(19) United States
(12) Patent Application Publication
(10) Pub. No.: US 2019/0050817 A1
(43) Pub. Date: Feb. 14, 2019

(54) METHOD AND SYSTEM FOR MANAGING EMPLOYEE SHIFT AND TRANSPORTATION

(71) Applicants: Jeffrey P. DeRouen, Youngsville, LA (US); Michael R. Solomon, JR., Pineville, LA (US)

(72) Inventors: Jeffrey P. DeRouen, Youngsville, LA (US); Michael R. Solomon, JR., Pineville, LA (US)

(21) Appl. No.: 16/158,125

(22) Filed: Oct. 11, 2018

Related U.S. Application Data
(60) Provisional application No. 62/713,551, filed on Aug. 2, 2018.

(51) Int. Cl. G06Q 10/10; G06Q 10/06; G06Q 10/02; G06Q 50/30

(52) U.S. Cl. CPC G06Q 10/1093; G06Q 10/063116; G06Q 50/30; G06Q 10/02; G06Q 10/1053

(57) ABSTRACT

The various embodiments herein provide a method for job management, shift management and transportation scheduling for an employee through a computer readable program. The computer readable program installed on an employee device receives a request for a job opening with location and shift details in a central server from a recruitment node. The recruitment node is referred to a computer readable program installed on an employers' computing device. The job details are accessed for the received request from the recruitment node and saved in a database residing in the central server. On the receipt of the request, a plurality of job candidates are notified based on a profile match with the job details. Further, a transportation based on a job location and a location of the employee selected for the corresponding job is scheduled.

### BACKGROUND

### Technical Field of Invention

The embodiments herein generally relate to a job management method and particularly relates to a method and system for managing an employee shift and arranging a transportation for the employee according to the shift. The present invention more particularly relates to a method, and system for scheduling varying shifts of employees at a plurality of locations of employment by utilizing scheduled mode of transportation.

### Description of Related Art

Currently shift management system optimizes an employee shift scheduling and alerting. The system ensures an organization to plan and schedule employee shifts without any complication ensuring a smooth process flow. It bridges the communication gap that can happen over manual methods and proactively manages and tracks employee shifts.

As soon as an organization has people associated with it then the issue of managing the schedules of workforce is required, amongst other issues, adequate personnel are present when the organization requires them, that holidays can be accommodated, sick days managed, and costs tracked or minimized.

Accordingly, the term of “shift” has become a common term to reflect a period of time that an employee works where multiple “shifts” for multiple employees combine to provide the right personnel mix over the period of time the organization is open. Shifts can include short shifts of a few hours through to extended night shifts, 12 hours shifts and be based upon work schedules in which employees change or rotate shifts or are scheduled based upon multiple factors.

For facilitating an efficient transition between the job application and a transportation scheduling, a plurality of prior art methods had been developed. One of such prior arts discloses an employee scheduling software system that accesses multiple extrinsic databases hosting schedules relating to an employee allowing scheduling to avoid external conflicts for the employer and allowing employees to respond to schedules as well as trade/auction with other employees with confidence. Further, by associating a portable electronic device to the employee and hosting a scheduling application on these devices the employees are able to review/modify/trade/auction shifts with increased flexibility and employers are provided with a more accurate clocking in/out process to verify the employee's attendance and completion of their shift.

Another prior art discloses a method for generating a transportation plan. A set of transportation requests are identified. An initial transportation plan having a set of vehicle routes, a set of vehicle schedules, and a set of crew schedules that satisfy the set of transportation requests is created. A set of vehicle routes, a set of vehicle schedules, and a set of crew schedules are simultaneously modified repeatedly using a policy to generate a new transportation plan until an objective is met.

The prior art methods require a human intervention to contact the employment venues to confirm availability. Further, the employee has to use secondary software applications to secure transportation for commuting to a determined place of employment.

The prior art methods are limited in assigning shifts to the individuals to a plurality of locations of employment based on job qualifications and arranging transportation for the employee through a single software application.

Therefore, there is a need for a method and system for managing a shift of an employee to a determined employment location through a computer readable program. Also, there is a need for a method and system for securing a transportation for an employee to a determined place of employment.

### SUMMARY OF THE INVENTION

The primary objective of the embodiments is to provide a method and system for managing a shift of an employee to a determined employment location through a computer readable program.

Another objective of the embodiments herein is to provide a method and system for securing a transportation for an employee to a determined place of employment.

Yet another object of the embodiments herein is to provide a method and system for selecting an employment candidate for a job application and sending an alert about the job details, shift details and transportation details to the candidate.

The various embodiments herein provide a method for job management, shift management and transportation scheduling for an employee through a computer readable program. The computer readable program installed on an employee device receives a request for a job opening with location and shift details in a central server from a recruitment node. The recruitment node is referred to a computer readable program installed on an employers' computing device. The job details are accessed for the received request from the recruitment node and saved in a database residing in the central server. On the receipt of the request, a plurality of job candidates are notified based on a profile match with the job details. The central server then sends a location and shift details to the selected job candidates based on a set of criteria to increase efficiency of the job outcome. Further, a transportation based on a job location and a location of the employee selected for the corresponding job is scheduled.

According to one embodiment herein, the set of criteria comprises a distance between a job location and the employee, an optimum availability of the employee during the scheduled shift for the job and a transportation availability and frequency in the employee departure area and the job location.

According to one embodiment herein, the computer readable program assesses a time for commutation and ease of transportation for the employee on the basis of relative location of the employee and the job.

According to one embodiment herein, the computer readable program monitors a shift schedule of a job and automatically reschedules a mode and time of transportation based on the shift timings.

According to one embodiment herein, the computer readable program monitors a real time location of the employee and automatically reschedules a mode and time of transportation based on the real time location of the employee.

According to one embodiment herein, the computer readable program collates an employee data and is automatically rated and shortlisted on a basis of an employment criteria set by the employer.

According to one embodiment herein, the computer readable program collates an employee data and is shortlisted by the employer preference.

According to one embodiment herein, the computer readable program provides an employment assistance, a shift scheduling and a transportation assistance for an ad-hoc as well as permanent job opportunities.

These and other aspects of the embodiments herein will be better appreciated and understood when considered in conjunction with the following description and the accompanied drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanied drawings in which:

FIG. 1 illustrates a flowchart for a method of shortlisting and alerting a candidate about an employment shift and transportation, according to an embodiment herein.

FIG. 2 illustrates a flowchart for a method of transportation scheduling for a shortlisted candidate, according to an embodiment herein.

FIG. 3 illustrates a flowchart for a method of shift management for an employee and transportation scheduling as per the shift, according to one embodiment herein.

### DETAILED DESCRIPTION OF THE DRAWINGS

In the following detailed description, a reference is made to the accompanied drawings that form a part hereof, and in which the specific embodiments that may be practiced is shown by way of illustration. The embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a method for job management, shift management and transportation scheduling for an employee through a computer readable program. The computer readable program installed on an employee device receives a request for a job opening with location and shift details in a central server from a recruitment node. The recruitment node is referred to a computer readable program installed on an employers' computing device. The job details are accessed for the received request from the recruitment node and saved in a database residing in the central server. On the receipt of the request, a plurality of job candidates are notified based on a profile match with the job details. The central server then sends a location and shift details to the selected job candidates based on a set of criteria to increase efficiency of the job outcome. Further, a transportation based on a job location and a location of the employee selected for the corresponding job is scheduled.

According to one embodiment herein, the set of criteria comprises a distance between a job location and the employee, an optimum availability of the employee during the scheduled shift for the job and a transportation availability and frequency in the employee departure area and the job location.

According to one embodiment herein, the computer readable program assesses a time for commutation and ease of transportation for the employee on the basis of relative location of the employee and the job.

According to one embodiment herein, the computer readable program monitors a shift schedule of a job and automatically reschedules a mode and time of transportation based on the shift timings.

According to one embodiment herein, the computer readable program monitors a real time location of the employee and automatically reschedules a mode and time of transportation based on the real time location of the employee.

According to one embodiment herein, the computer readable program collates an employee data and is automatically rated and shortlisted on a basis of an employment criteria set by the employer.

According to one embodiment herein, the computer readable program collates an employee data and is shortlisted by the employer preference.

According to one embodiment herein, the computer readable program provides an employment assistance, a shift scheduling and a transportation assistance for an ad-hoc as well as permanent job opportunities.

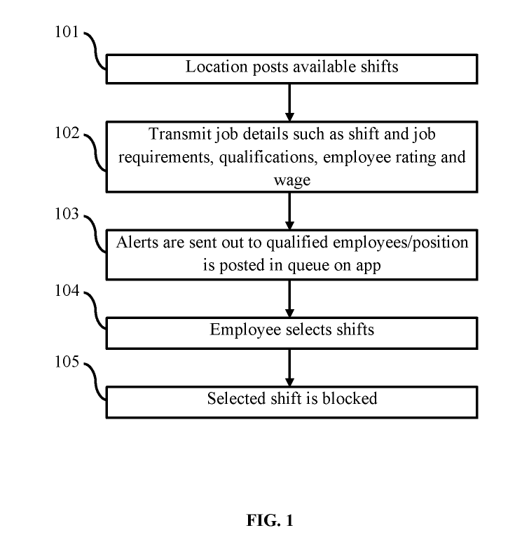

FIG. 1 illustrates a flowchart for a method of shortlisting and alerting a candidate about an employment shift and transportation, according to an embodiment herein. With respect to FIG. 1, a plurality of employers and employees are registered through the computer readable program. The employer posts a job opening for a given location, and shift schedules (101). The posting comprises a job requirement, a qualification of the employee, wages and an employee rating on the computer readable program (102). The employee rating is an average rating provided by the previous employers, management and colleagues of the employee. The computer readable program shortlists a plurality of registered candidates on the basis of posting and sends notifications to the selected candidates for the job posting (103). The employee is facilitated to confirm for the job posting and select a shift suited to the employee's schedule (104). The selected shift slot vacancy is updated (105).

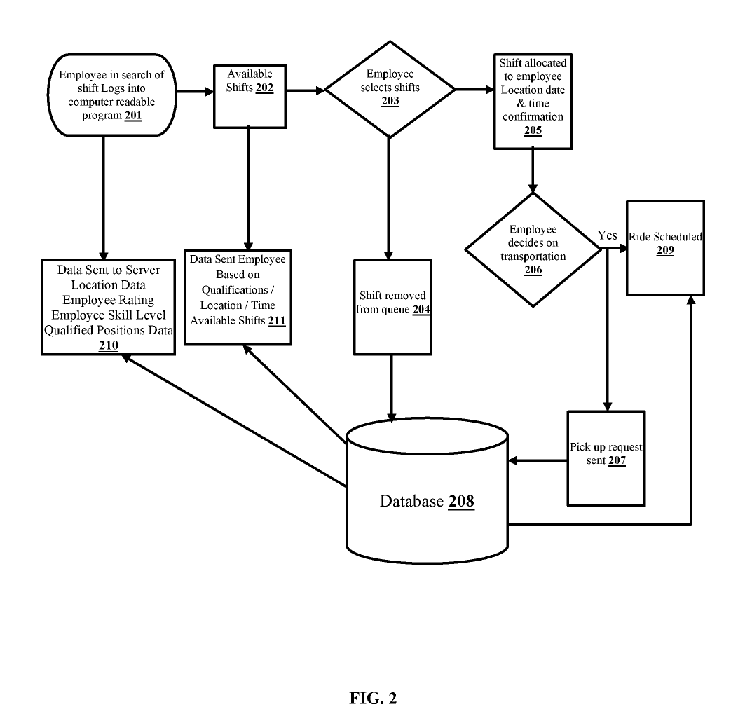

FIG. 2 illustrates a flowchart for a method of transportation scheduling for a shortlisted candidate, according to an embodiment herein. With respect to FIG. 2, the employee is facilitated to search for an available job or an available shift of an ongoing job by logging into the computer readable program (201). The computer readable program shortlists available shift for the employee (202). The employee further provides personal details comprising current location, skills, expertise, experience, rating from previous jobs, and qualified positions. The personal details are transmitted and saved in the central server (210). On receiving the employee data, an available shift list is presented to the employee on the basis of personal details of the employee (211). The employee selects the available shift resulting in removal of the shift slot from the available shift list and the information about the updated shift is saved in the database (203-205). The central server sends a confirmation alert to the employee for booked shift slot and date after receiving confirmation from the employer (206). The employee further selects a transportation option. On confirmation of the transportation requirement by the employee, a request for pick up is sent to the central server and a transportation medium is booked for the employee for given date and shift time (207-209).

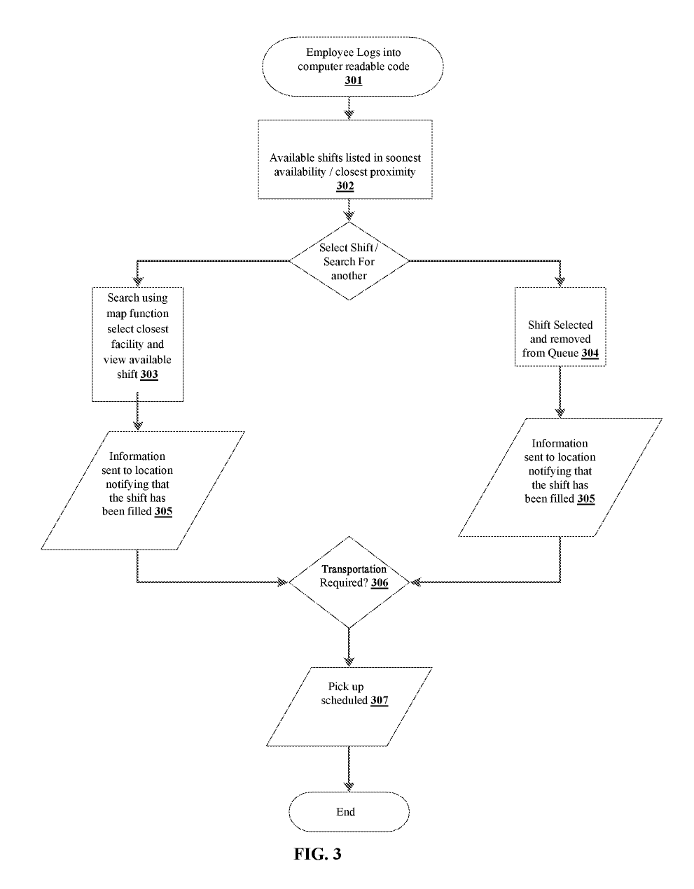

FIG. 3 illustrates a flowchart for a method of shift management for an employee and transportation scheduling as per the shift, according to one embodiment herein. With respect to FIG. 3, the shift allocation comprises presentation of available shift to the logged in employee on the basis of his or her persona details (301-302). The available shifts are listed based on earliest availability and closest proximity. The employee is facilitated to either directly select the shift from the list on the basis of data shown pertaining to earliest availability of the shift and proximity from the employee location or the employee is facilitated to view the shifts on a map (303-304). The map is integrated into the computer readable program to show the shift timings, location of shifts and transportation status. On entering a selection by the employee, the data is sent to the central server which block the shift slot and job opening (305). Further, the central server sends a notification to the employee for requirement of a private or public transportation for the booked shift (306). On receiving a confirmation from the employee, the central server schedules a pick-up ride for the employee and transmits a payment details to the employee (307).

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the claims.

I claim:

1. A method for job management, shift management and transportation scheduling for an employee through a computer readable program, wherein the method comprises the steps of:
receiving a request for a job opening with location and shift details in a central server from a recruitment node;
accessing job details for the received request from the recruitment node and saving the job details in a database residing in the central server;
notifying a plurality of job candidates based on a profile match with the job details;
sending a location and shift details to the selected job candidates based on a set of criteria to increase efficiency of the job outcome;
scheduling a transportation based on a job location and a location of the employee selected for the corresponding job.

2. The method as claimed in claim 1, wherein the set of criteria comprises a distance between a job location and the employee, an optimum availability of the employee during the scheduled shift for the job and a transportation availability and frequency in the employee departure area and the job location.

3. The method as claimed in claim 1, wherein the computer readable program assesses a time for commutation and ease of transportation for the employee on the basis of relative location of the employee and the job.

4. The method as claimed in claim 1, wherein the computer readable program monitors a shift schedule of a job and automatically reschedules a mode and time of transportation based on the shift timings.

5. The method as claimed in claim 1, wherein the computer readable program monitors a real time location of the employee and automatically reschedules a mode and time of transportation based on the real time location of the employee.

6. The method as claimed in claim 1, wherein the computer readable program collates an employee data and is automatically rated and shortlisted on a basis of an employment criteria set by the employer.

7. The method as claimed in claim 1, wherein the computer readable program collates an employee data and is shortlisted by the employer preference.

8. The method as claimed in claim 1, wherein the computer readable program provides an employment assistance, a shift scheduling and a transportation assistance for an ad-hoc as well as permanent job opportunities.
